(19) United States
(12) Patent Application Publication
(10) Pub. No.: US 2003/0074996 A1
(43) Pub. Date: Apr. 24, 2003

(54) Steering gear

(76) Inventor: Eckart Op Den Camp, Koblenz, DE (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/236,073

(22) Filed: Sep. 5, 2002

(30) Foreign Application Priority Data
Sep. 6, 2001 (DE) 20114759.9

(51) Int. Cl. F16H 55/18; F16H 1/04

(52) U.S. Cl. 74/422; 74/409

(57) ABSTRACT

A steering gear comprising a housing, a drive pinion, a gear rack, a thrust pad, a compensating member and a torsion spring. In this steering gear, the gear rack is shiftable in said housing and the thrust pad is biasing the gear rack against the drive pinion. Further, the compensating member has a cam surface, the cam surface is supporting the thrust pad; the torsion spring is exerting a torque upon the compensating member and the torque is causing the compensating member to urge the thrust pad from the compensating member towards the drive pinion.

### TECHNICAL FIELD

The invention relates to a steering gear comprising a housing, a gear rack shiftable in the housing, a drive pinion and a thrust pad which biases the gear rack against the drive pinion.

### BACKGROUND OF THE INVENTION

Generic steering gears serve to convert the movements of the steering wheel implemented by the driver into a change in the positioning of the road wheels located generally on an axle. In prior art steering gears the rotational movement of the steering wheel is converted into a rotational movement of a drive pinion accommodated in a housing of the steering gear. The drive pinion acts on the shiftable gear rack of the steering gear which in turn acts via a linkage on the wheels to be steered. The shiftable gear rack located in the housing is biased by a thrust pad such that it is forced against a drive pinion. The pressure exerted by the thrust pad on the gear rack is dimensioned such that an optimum connection between gear rack and drive pinion exists in thus achieving a smooth steering response. It is usually a spring which urges the thrust pad with a predefined preload against the backs of the gear rack. Since in the course of operation, wear materializes between drive pinion and gear rack, on the one hand, and between gear rack and thrust pad, on the other, the initially good power transfer between gear rack and drive pinion will invariably deteriorate with time on prior art steering gears. This is why it becomes necessary to reset the steering gear from time to time. Such tasks are complicated and thus expensive.

It is the objective of the invention to improve the generic steering gear in a way to achieve smooth motion and satisfactory power transfer in all operating conditions and to minimize the maintenance requirement even after long-time use.

### BRIEF SUMMARY OF THE INVENTION

In accordance with the invention there is provided a steering gear comprising a housing, a drive pinion, a gear rack, a thrust pad, a compensating member and a torsion spring, the gear rack being shiftable in the housing, the thrust pad biasing the gear rack against the drive pinion, the compensating member having a cam surface, the cam surface supporting the thrust pad, the torsion spring exerting a torque upon the compensating member and the torque causing the compensating member to urge the thrust pad from the compensating member towards the drive pinion. This results in the compensating member urging the gear rack, via the thrust pad, against the drive pinion to automatically compensate increasing wear. This configuration of the gear simplifies, for one thing, line assembly since certain steps in adjustment no longer need to be implemented. For another, tolerances in components can now be compensated and thus these can be machined with lesser accuracy. It is particularly of advantage that service or repair work now no longer needs to be implemented in compensating wear of the steering gear in vehicle operation.

In accordance with one preferred embodiment of the invention it is provided for that the cam surface area of the compensating member comprises helicoidal pitch cam surface areas and that two of the pitch cam surface areas each cover an angle of 180°. This thus achieves a particularly advantageous aspect permitting the forces to be introduced symmetrically from the compensating member to the thrust pad.

### BRIEF DESCRIPTION OF THE DRAWINGS

Further advantage aspects of the invention read from the sub-claims.

The invention will now be detailed with reference to a preferred embodiment as shown in the attached drawings in which:

FIG. 1 is a plan view of the steering gear with the housing partly sectioned,

FIG. 2 is a partly sectioned view of the steering gear in accordance with the invention as taken along the line II-II in FIG. 2; and

FIG. 3 is a detail view of the compensating member of the steering gear.

### DETAILED DESCRIPTION OF THE PREFERRED EMBODIMENTS

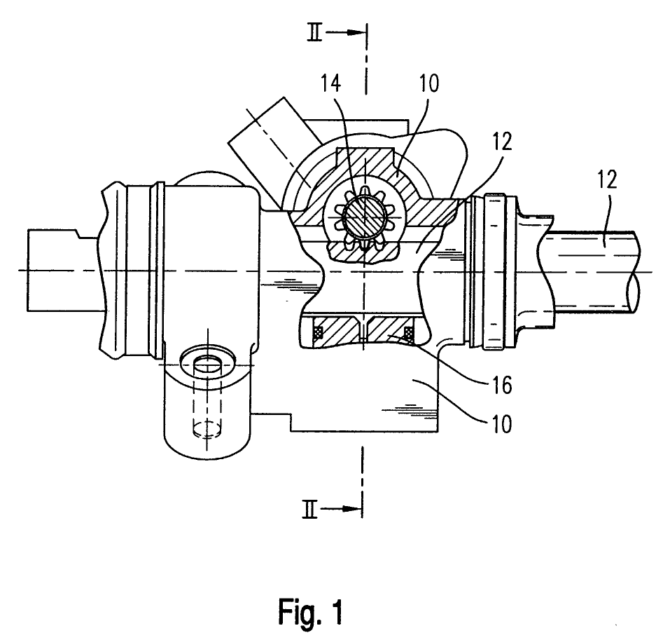

Referring now to FIG. 1 there is illustrated the steering gear in accordance with the invention. Accommodated in a housing 10 is a shiftable gear rack 12 in connection with a wheel axle (not shown), a drive pinion 14 connecting via a steering shaft (not shown) a steering wheel (likewise not shown), and a thrust pad 16 biasing the gear rack against the drive pinion.

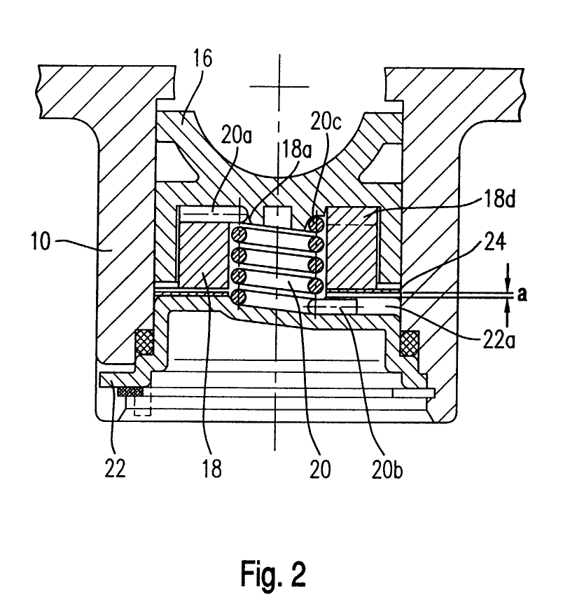

Referring now to FIG. 2 there is illustrated in detail on a magnified scale the thrust pad of the steering gear. Supported by the thrust pad 16 is a compensating member 18. A torsion spring 20 configured as a leg spring rests by a first leg 20a at a radially extending boss 18a of the compensating member, resulting in the location of the first spring leg 20a being reliably defined. A second leg 20b of the torsion spring 20 is supported by a supporting disk 22. The supporting disk is provided with a disk groove 22a in which the second leg 20b is received whereby the torsion spring 20 is reliably fixed in place. The leg spring features several coils 20c. Between the flat underside of the compensating member 18 and the supporting disk 22 a crinkled spring washer 24 is provided (spring excursion a). Thus, inaccuracies resulting from machining the toothing of the drive pinion 14 and gear rack 12 can be compensated to prevent jamming in longitudinal movement of the gear rack. A typical value for the spring excursion a is 0.1 to 0.2 mm.

By means of the force acting from the first leg 20a on the boss 18a, the torsion spring 20 biases the compensating member 18 with a torque in such a manner that the compensating member is urged against the thrust pad. The coils 20c endow the torsion spring 20 with a second function as a thrust spring. This is particularly of advantage since the torsion spring 20 likewise urges the thrust pad 16 axially against the drive pinion.

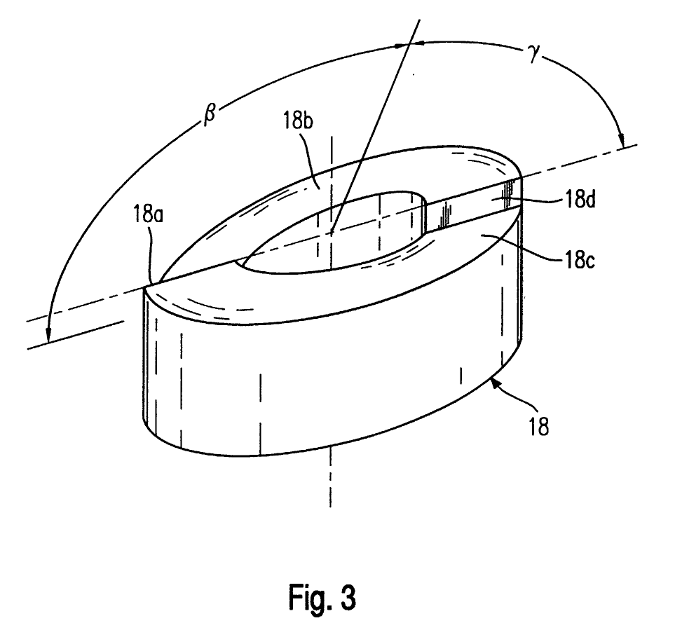

Referring now to FIG. 3 there is illustrated in detail a preferred embodiment of the compensating member 18 in an annular configuration. Pitch cam surface areas (18b, 18c) of the compensating member are configured helicoidal, each covering an angle of 180°. The bosses 18a, 18d separate the pitch cam surface area 18b from the pitch cam surface area 18c. The torsion spring is arranged in the interior (see FIG. 2) of the annular compensating member 18 as shown in this case to thus make for a particularly compact and space-saving configuration. In the preferred embodiment shown in this Figure the pitch of the pitch cam surface areas (18b, 18c) is very small with 6°. Therefore the friction forces between the compensating member 18 and the thrust pad 16 are sufficiently high to prevent the thrust pad, which is biased by the gear rack, from being able to escape downwards with reference to FIG. 2. The diameter of the compensating member 18 is selected with approximately 20 mm so that the rise of the pitch cam surface areas (18b, 18c) over an arc β amounts to approximately 3 mm, the arc β forming the range for resetting the compensating member. A second arc γ=180°−β defines the minimum contact surface area between the pitch cam surface area 18b or 18c, on the one hand, and the surface area of the thrust pad 16 opposite thereto, on the other, as needed to attain reliable contact between thrust pad 16 and compensating member 18 at minimum pressure.

1. A steering gear comprising a housing, a drive pinion, a gear rack, a thrust pad, a compensating member and a torsion spring, said gear rack being shiftable in said housing, said thrust pad biasing said gear rack against said drive pinion, said compensating member having a cam surface, said cam surface supporting said thrust pad, said torsion spring exerting a torque upon said compensating member and said torque causing said compensating member to urge said thrust pad from said compensating member towards said drive pinion.

2. The steering gear as set forth in claim 1, wherein said cam surface comprises helicoidal pitch cam surface areas.

3. The steering gear as set forth in claim 2, wherein said pitch cam surface areas each cover an angle of 180°.

4. The steering gear as set forth in claim 1, wherein said pitch cam surface areas each have a pitch, said pitch being so small that an automatic lock occurs relative to said thrust pad.

5. The steering gear as set forth in claim 1, wherein said pitch of said pitch cam surface areas is approximately 6°.

6. The steering gear as set forth in claim 1, wherein said compensating member has a diameter, said diameter being selected such that the rise of each pitch cam surface area within a defined arc is approximately 3 mm.

7. The steering gear as set forth in claim 1, wherein said torsion spring is a leg spring having several coils, said leg spring likewise acting as a thrust spring biasing said thrust pad in a direction toward said drive pinion.

8. The steering gear as set forth in claim 1, wherein said compensating member is provided with a radially extending boss, said torsion spring having a first leg, said first leg resting on said boss.

9. The steering gear as set forth in claim 1, wherein a supporting disk is provided, said spring having an end facing away from said thrust pad, said supporting disk supporting said spring on said end, said supporting disk being provided with a disk groove, said spring being provided with a second leg, said second leg being accommodated in said disk groove.

10. The steering gear as set forth in claim 1, wherein said compensating member is configured annular and said torsion spring is arranged in the interior of said compensating member, a crinkled spring washer being disposed between said compensating member and said supporting disk.
